(19) United States
(12) Patent Application Publication
(10) Pub. No.: US 2021/0245031 A1
(43) Pub. Date: Aug. 12, 2021

(54) HUMAN-MACHINE INTERACTION VEHICLE

(71) Applicant: HANGZHOU CHIC INTELLIGENT TECHNOLOGY CO., LTD, Hangzhou (CN)

(72) Inventor: Jiawei YING, Zhejiang (CN)

(73) Assignee: HANGZHOU CHIC INTELLIGENT TECHNOLOGY CO., LTD, Hangzhou (CN)

(21) Appl. No.: 17/240,939

(22) Filed: Apr. 26, 2021

Related U.S. Application Data
(63) Continuation of application No. 15/939,264, filed on Mar. 28, 2018.
Application No. 15/939,264 is a continuation-in-part of application No. 15/493,217, filed on Apr. 21, 2017, now Pat. No. 10,144,451.
Application No. 15/493,217 is a continuation-in-part of application No. PCT/CN2016/100984, filed on Sep. 30, 2016.
Application No. 15/493,217 is a continuation of application No. 15/193,856, filed on Jun. 27, 2016, now Pat. No. 9,656,688.

(30) Foreign Application Priority Data
Oct. 1, 2015 (CN) 201510666424.6
Oct. 10, 2015 (CN) 201510651451.6

(51) Int. Cl. A63C 17/00; A63C 17/12; A63C 17/01

(52) U.S. Cl. CPC A63C 17/0093; A63C 17/12; A63C 17/014; A63C 2017/1463; A63C 2203/18; A63C 2203/12; A63C 17/011

(57) ABSTRACT

A human-machine interaction vehicle includes a vehicle body and a pair of wheels coupled with the vehicle body. The vehicle body includes a support frame, at least one pedal disposed on the support frame, a first position sensor, and a controller. The support frame is rotatably connected to the wheels. The first position sensor is configured to detect attitude information of the two pedals relative to the support frame. The actuation device drives the wheels to rotate based on the attitude information. The human-machine interaction vehicle includes a support frame, and the pedal is arranged on the support frame independently.

### CROSS-REFERENCE TO RELATED APPLICATIONS

This application is a continuation application of and claims the priority benefit of U.S. patent application Ser. No. 15/939,264, filed on Mar. 28, 2018, now pending. The prior U.S. patent application Ser. No. 15/939,264 claims all benefits accruing under 35 U.S.C. § 119 from China Patent Application No. 201510666424.6, filed on Oct. 1, 2015 in the State Intellectual Property Office of China, the content of which is hereby incorporated by reference. The prior U.S. patent application Ser. No. 15/939,264 is a continuation-in-part under 35 U.S.C. § 120 of international patent application PCT/CN2016/100984, filed on Sep. 30, 2016, the content of which is also hereby incorporated by reference. The prior U.S. patent application Ser. No. 15/939,264 is also a continuation-in-part of U.S. patent application Ser. No. 15/493,217 filed on Apr. 21, 2017, which is a continuation of U.S. patent application Ser. No. 15/193,856 filed Jun. 27, 2016, the content of which is also hereby incorporated by reference.

### FIELD OF THE DISCLOSURE

The present disclosure relates to human-machine interaction self-balancing vehicles, and more particularly, to a human-machine interaction vehicle.

### BACKGROUND OF THE DISCLOSURE

Human-machine interaction vehicles, also called electric self-balancing vehicles or sensor-controlled vehicles, generally work based on a basic principle of “dynamic stabilization.” In a vehicle body of a human-machine interaction vehicle, a gyroscope may cooperate with an accelerometer to detect the change of the vehicle body's attitude or orientation, and a servo control system can precisely control the vehicle body to adjust its posture, thereby balancing the vehicle.

The human-machine interaction vehicles generally have two categories: with a handle bar, and without a handle bar. In particular, a human-machine interaction vehicle with a handle bar can be manipulated to move forward, move backward, and make turns by controlling the handle bar. A human-machine interaction vehicle without a handle bar can move forward and backward by tilting the vehicle body, and can make turns by rotating two pedals by the user's feet. An example of a human-machine interaction vehicle without a handle bar can be a two-wheel self-balancing vehicle disclosed by Chinese Patent Application No. CN201320300947. The two-wheel self-balancing vehicle includes a vehicle bottom frame and an internal cover, and the internal cover is composed of a left internal cover and a right internal cover symmetric with each other. The left internal cover is rotatably connected to the right internal cover.

### SUMMARY OF THE DISCLOSURE

To solve the above-mentioned problem, a human-machine interaction vehicle of a simple structure is provided.

A human-machine interaction can include a vehicle body and a pair of wheels coupled with the vehicle body. The vehicle body can include a support frame, at least one pedal, a first position sensor, and a controller. The at least one pedal can be located on the support frame. The support frame can be rotatably connected to the pair of wheels. The first position sensor can be configured to detect attitude information (e.g., orientation information) of a user standing on the at least one pedal. The controller can be configured to drive the wheels to rotate based on the detected attitudes information.

The at least one pedal can be rotatably connected on the support frame, the attitude information is a tilt angle, and the first position sensor can be configured to detect the tilt angle of the at least one pedal relative to the support frame.

The support frame can be a rigid shaft, two opposite ends of the rigid shaft can be rotatably connected to the pair of wheels respectively, the first position sensor can be configured to detect rotation angle of the at least one pedal relative to the rigid shaft, and the rotation angle can be a tilt angle of the at least one pedal relative to the support frame.

The pedal area can be a receiving groove recessed towards an inside of the support frame, a protrusion facing towards the pair of wheels can be provided at each side of the at least one pedal, and the at least one pedal can be pivoted to the vehicle body via the protrusion.

The at least one pedal can comprise a plurality of flexible supports configured to make the at least one pedal return or buffer.

The attitude information can be position information, and the first position sensor can be configured to detect of the position information of the user standing on the at least one pedal.

The first position sensor can be a flexible support arranged between the at least one pedal and the support frame, and the first position sensor can be configured to detect deformation amounts of the flexible support in different directions, in order to detect the attitude information of the user standing on the at least one pedal.

The first position sensor can be configured to detect amount of deformation of the flexible support based on the balanced position of the flexible support, in order to detect the attitude information of the user standing on the at least one pedal.

The vehicle body further can comprise at least two flexible supports arranged between the at least one pedal and the support frame in different directions, and the first position sensor can be configured to detect deformation amounts of the flexible supports in different directions, in order to detect the position information of the user standing on the at least one pedal.

The first position sensor can be a pressure sensor, and the pressure sensor can be configured to detect pressure on the at least one pedal, in order to detect the attitude information of the user standing on the at least one pedal.

The at least one pedal can be rotatably connected on the support frame, and the first position sensor can be configured to detect rotation information of the at least one pedal.

A pressure sensor or a plurality of pressure sensors can be arranged in the at least one pedal.

The attitude information can be pressure information, and the first position sensor can be configured to detect the pressure information of the at least one pedal.

The first position sensor can be configured to detect pressure value information of the user standing on the at least one pedal, and the controller can be configured to drive the pair of wheels to rotate based on the detected pressure value information and make turns based on speed difference of the pair of wheels.

The first position sensor can be further configured to detect whether the at least one pedal is pressed or not in order to control the pair of wheels to rotate or stop.

The first position sensor can be a tracking ball placed into a space between the at least one pedal and the support frame with a capability of freely moving in arbitrary directions in the space, and the attitude information of the user standing on the at least one pedal can be detected by detecting a relative position of the tracking ball with respect to the at least one pedal.

A pedal area can be defined on a side of the support frame away from the ground and configured for two feet while standing, the at least one pedal is respectively disposed in the pedal area, and when the attitude information in different directions is asymmetrical, the vehicle body can make turns.

The first position sensor can be arranged between the at least one pedal and the support frame, and the at least one pedal sways toward or away from the support frame based on the first position sensor as a fulcrum.

The first position sensor can be arranged between the at least one pedal and the support frame, the at least one pedal can be movably connected to the support frame, and the first position sensor can be located beside a fulcrum.

Two pedal areas can be defined on a side of the support frame away from the ground, the vehicle body can comprise two pedals, the two pedals can be respectively disposed in the two pedal areas, and when the attitude information of the two pedals is asymmetrical, the vehicle body can make turns.

A pedal area can be defined on a side of the support frame away from the ground and configured for one foot standing, the vehicle body can comprise a pedal, the pedal can be respectively disposed in the pedal area, and the vehicle body can make turns based on the attitude information of the pedal.

The support frame can be a rigid plate-type structure.

An extractable shell can be arranged on a side of the support frame, the extractable shell can comprise a first shell and a second shell, the first shell and the second shell can be extracted along a direction perpendicular to an axle of the wheels, the extractable shell can comprise two end portions facing the wheels, a side portion for connecting the two end portions, a top portion away from the ground, a bottom portion facing to the top portion, and a groove arranged on the top portion and configured to accommodate the at least one pedal.

The first shell and the second shell can be extracted forward or backward parallel to the ground.

The vehicle body can further comprise a second position sensor configured to detect tilt information of the support frame relative to the ground, the controller can be configured to drive the wheels to move forward or backward based on the tilt information detected by the second position sensor, and the controller can be configured to drive the wheels to make turns based on the attitude information detected by the first position sensor.

The human-machine interaction vehicle can include a support frame of an integrated structure between the pair of wheels. The pedal can be arranged on the support frame independently. The human-machine interaction vehicle can have a simple structure, omitting two rotatably connected structures configured to install two pedals separately.

### BRIEF DESCRIPTION OF THE DRAWINGS

References are made to the accompanying drawing(s) to better illustrate the present invention. However, the accompanying drawings represents only some embodiments of the disclosure, and are not meant to be exhaustive.

FIG. 1 is an exploded diagram of a human-machine interaction vehicle according to a first embodiment of the disclosure.

FIG. 2 is a perspective view of the human-machine interaction vehicle according to the first embodiment of the disclosure.

FIG. 3 is an exploded diagram of the human-machine interaction vehicle of FIG. 2.

FIG. 4 is a partly exploded diagram of the human-machine interaction vehicle of FIG. 2.

FIG. 5 is a partly exploded diagram of the human-machine interaction vehicle of FIG. 4.

FIG. 6 is a perspective view of the pedal and the plurality of flexible supports of the human-machine interaction vehicle of FIG. 4.

FIG. 7 is a perspective view of a human-machine interaction vehicle according to a second embodiment of the disclosure.

FIG. 8 is a perspective view of a human-machine interaction vehicle according to a third embodiment of the disclosure.

FIG. 9 is a perspective view of a human-machine interaction vehicle according to a fourth embodiment of the disclosure.

### DETAILED DESCRIPTION OF THE DISCLOSURE

The following description will render a clear and complete description of the present disclosure in combination with the embodiments and accompanying drawings. Obviously, the embodiments described herein are only part but not all embodiments of the disclosure. Any other embodiments obtained by those of skill in the art without making inventive efforts shall all be covered within the protection of the disclosure.

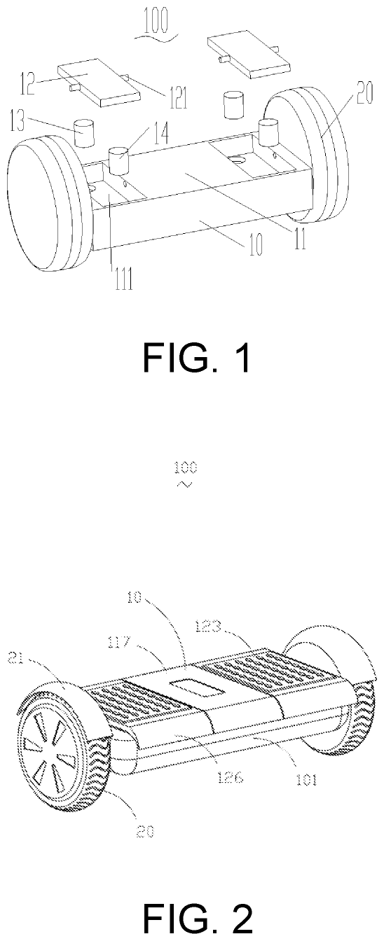

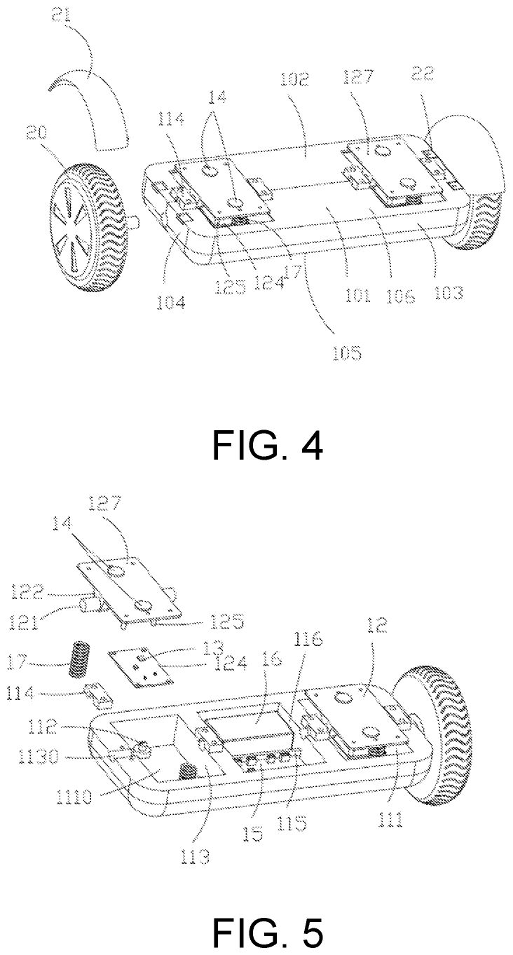

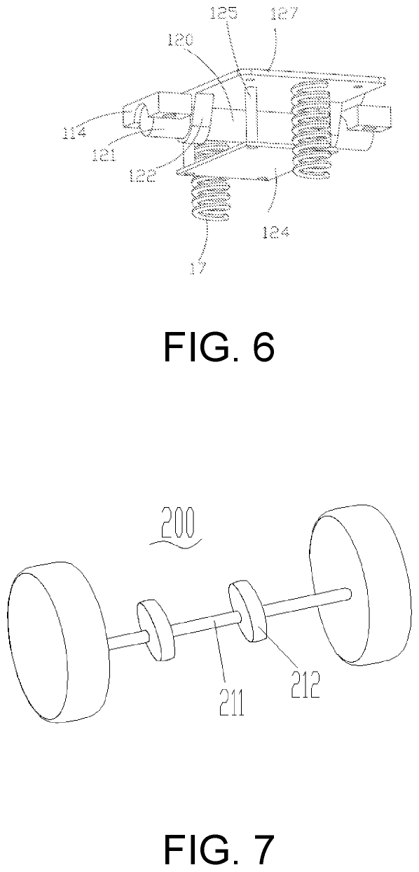

Referring to FIGS. 1 to 6, a human-machine interaction vehicle 100 of the first embodiment is provided. The human-machine interaction vehicle 100 can include a vehicle body 10 and a pair of wheels 20 coupled with the vehicle body 10.

Planes of the pair of wheels 20 may be substantially parallel with each other, and axles of the pair of wheels 20 can be aligned in substantially the same imaginary straight line. The pair of wheels 20 may be assembled to opposite sides of the vehicle body 10 through the respective axles. For example, the pair of wheels 20 may be assembled to opposite ends of the vehicle body 10, respectively, or assembled at two sides under the vehicle body 10. In this embodiment, the pair of wheels 20 may be rotatably coupled with opposite ends of the vehicle body 10. The human-machine interaction vehicle 100 can make turns or move based on attitude information of a user standing on the pedal, and can be controlled by the controller 15. The first position sensor 13 can be configured to detect the attitude information of the user standing on the pedal and send the detected attitude information to the controller 15. The controller 15 can be configured to control the pair of wheels 20 to rotate, resulting in the human-machine interaction vehicle 100 being controlled to move forward or backward, or make turns by the user. The attitude information of the user standing on the at least one pedal can be position information of the user standing on the at least one pedal, tilt information of the at least one pedal relative to the ground, mechanical pressure information of the user standing on the at least one pedal, capacitance pressure information or inductance pressure information of the user standing on the at least one pedal, or position information of a rotating tracking ball.

The support frame 11 can be an integrated structure and rotatably connected to the pair of wheels 20. The words “integrated structure” may mean the constituent parts of the support frame 11 cannot be moved with respect to each other so that the support frame 11 is substantially an integral piece or a unitary structure. The support frame 11 can be formed into an integrated structure by molding, welding, or riveting. The support frame 11 can be of any shape, such as a rigid plate-type structure or a rigid shaft. The human-machine interaction vehicle 100 includes a support frame of an integrated structure between the pair of wheels 20. The at least one pedal 12 can be arranged on the support frame 11 independently. Two rotatably connected structures configured to install the pedal are unnecessary. The provided human-machine interaction vehicle 100 can have a simple and whole structure, and can have strong expandability, omitting a direction pillar and two rotatably connected structure configured to install two pedals separately. The vehicle body of the provided human-machine interaction vehicle 100 can be much more robust.

Preferably, the support frame 11 has a shape of a boat and includes a pedal area 111. The pedal area 111 includes two receiving grooves 1110 and a receiving area 116 located between the two receiving grooves 1110 and used for accommodating the power source 16 and the controller 15. The controller 15 can have a main circuit board. A clipboard 115 can be arranged between the power source 16 and the controller 15 and configured to separate and prevent affecting each other.

A cover 117 can be arranged over the receiving area 116 and used for protecting the power source 16 and the controller 15.

The pedal 12 can be rotatably connected to the support frame 11, and when the pedal 12 is pressed by the user the pedal 12 tilts upward or downward. The type of rotatable connection can be by connecting with a single fulcrum, or two fulcrums. In the type of rotatably connecting with a single fulcrum, the pedal 12 rotates on the single fulcrum relative to the support frame in different directions. In the type of rotatably connecting with two fulcrums, the pedal 12 can be rotatably connected to the support frame 11 along an axle of the wheels, or rotatably connected to the support frame 11 along a radial direction of the wheels. The type of rotatably connecting with two fulcrums is arbitrary. As shown in the first embodiment of FIG. 1, the pedal 12 is rotatably connected to the support frame 11 along the axle of the wheels 20. When the user stands on the pedal 12, the pedal rotates around the pedal 12 and a tilt angle is formed between the pedal 12 and the support frame 11. In the first embodiment, the pedal 12 rotates on two protrusions pivoted to the support frame 11.

The pedal 12 can be of any shape. In the first embodiment, the pedal 12 is a plate-type structure. The pedal 12 can be configured to the support a standing user.

Referring to FIGS. 1 to 6, FIG. 8, and FIG. 9, the support frame 11 can be a rigid plate-type structure. The support frame 11 can be an integrated structure and stable. The user standing on the support frame 11 feels much more stable, and the vehicle body 10 has more simple structure and can be assembled easily.

The vehicle body can further include an extractable shell arranged on the support frame 11 and can be extracted along a direction perpendicular to a radial direction of the wheels 20. The extractable shell can include a first shell 101 and a second shell 102. The first shell 101 and the second shell 102 can be extracted along an axle of the wheels 20. The extractable shell can include two end portions 104 facing the wheels 20, a side portion 103 using for connecting the two end portions 104, a top portion 106 away from the ground, and a bottom portion 105 facing the top portion 106. A groove 107 can be arranged on the top portion 106 and configured to accommodate the pedal 12.

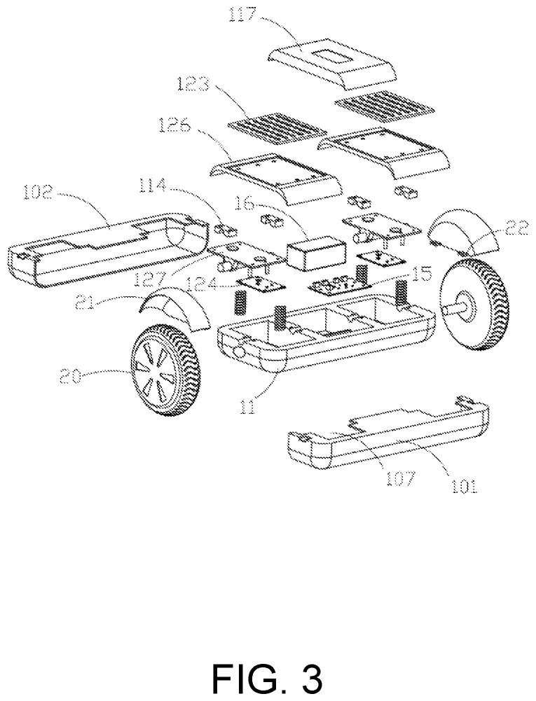

Referring to FIG. 3, the extractable shell can be extracted along a direction of the human-machine interaction vehicle 100 moving forward or backward. The first shell 101 can be extracted along a direction from forward to backward and sheathed in the support frame 11. The second shell 102 can be extracted along from backward to forward and sheathed in the support frame 11. In this embodiment, the second shell 102 can be symmetrical with the first shell 101. Alternatively, the second shell 102 may not be symmetrical with the first shell 101, the first shell 101 and the second shell 102 are assembled along upward or downward, or have an arbitrary angle with the radial direction of the wheels, or the axle of the wheels.

The pedal 12 can include a plate-type footboard 127, a fixing element 122 assembled to or integrated into a downside of the pedal 12, and a mounting shaft 120 assembled to or integrated into the fixing element 122. A protrusion 121 facing towards the wheels 20 is provided at the mounting shaft 120 and covers part of the pedal 12. So the mounting shaft 120 makes the pedal 12 stronger. The protrusion 121 can be formed at the fixing element 122 or the footboard 127, or assembled on the fixing element 122 or the the footboard 127. A plurality of mounting pillars 125 can be extended from the footboard 127 and configured to fix a sub-circuit board 124.

A pedal cover 126 can be located on the pedal 12. The pedal cover 126 can be fixed on the pedal 12. A non-slip mat 123 can be arranged on the pedal cover 126 and used for the standing user. Alternatively, the pedal cover 126 can be fixed on the support frame 11 or the extractable shell. A middle of the pedal cover 126 can be hollow or be a flexible structure, so the pedal 12 can be move upward or downward or tilt when the non-slip mat 123 is pressed by the user, and the first position sensor can detect the attitude information.

Preferably, the pedal area 111 can be a plurality of receiving grooves 1110 recessed towards an inside of the support frame 11. A protrusion 121 facing towards the wheels 20 can be provided at each side of the pedal 12, and the pedal 12 can be pivoted to the vehicle body 10 via the protrusion 121, such that the two pedals 12 are rotatably connected to the support frame 11. The protrusion 121 can be arranged on the vehicle body 10 and coupled with the pedal 12.

A support structure 113 can be arranged between the receiving area 116 and the receiving groove 1110 structure and configured to support and pivot to the protrusion 121 of the pedal 12. The support structure 113 can be integrated into the support frame 11, or assembled to the support frame 11. A pivoted recess 1130 can be located on the support structure 113 and the support frame 11 and configured to pivot to the protrusion 121. A fixing structure 114 can be located above the pivoted recess 1130 and configured to fix the protrusion 121. The fixing structure 114 can be integrated into the support frame 11 or assembled to the support frame 11.

Referring to FIG. 7, a second embodiment of a human-machine interaction vehicle 200 includes a support frame 11, which can be a rigid shaft. Opposite ends of the rigid shaft are rotatably connected to the pair of wheels, respectively. In detail, when the pedal is sheathed in the rigid shaft, the pedal can rotate relative to the rigid shaft, or cannot rotate relative to the rigid shaft. If the pedal cannot rotate relative to the rigid shaft, the rigid shaft can be fixed to the pedal and rotate together with the pedal. If the pedal rotates relative to the rigid shaft, a limiting structure can be provided and configured to limit a rotation angle of the pedal relative to the rigid shaft. The first position sensor 13 can be configured to detect a rotation angle of the pedal 12 relative to the rigid shaft, which is also regarded as tilt angle of the pedal 12 relative to the support frame 11, resulting in detecting the attitude information of the user.

The pedal 12 can further include a plurality of flexible supports 17. The plurality of flexible supports 17 can be configured to make the pedal 12 return and form a buffer to the pedal 12. After the pedal 12 tilts upward or downward, the plurality of flexible supports 17 can return the pedal 12 or provide a buffer force when the user is standing on the pedal 12. Therefore, the user will feel comfortable, the internal anti-vibration of the vehicle body 10 will be stronger, and the internal structure of the vehicle body 10 is much more stable. The plurality of flexible supports can be springs. The springs can be fixed on a fixing protrusion 112 of the receiving groove 1110, or the footboard 127. The plurality of flexible supports can be torsion springs (not shown).

The pedal 12 can be pressed by one foot or two feet.

A pedal area can be defined on a side of the support frame away from the ground and configured for two feet while standing, the at least one pedal is disposed in the pedal area. When the attitude information in different directions is asymmetrical, the vehicle body makes turns.

In use, one pedal 12 can be provided and the attitude information of the user standing on the pedal 12 can be detected by the first position sensor, resulting in the rotation of the pair of wheels 20. The user can stand on the pedal 12 by one foot or two feet, or sit on the pedal 12 to manipulate the human-machine interaction vehicle 100, which further adds fun in the process of manipulation. The first position sensor 13 can be arranged between the pedal 12 and the support frame 11, and the pedal 12 can sway toward or away from the support frame 11 based on the first position sensor 13 as a fulcrum. Thus, the first position sensor 13 can be used as the fulcrum itself, and the structure of vehicle body can be simple and assembled easily. Also, the first position sensor 13 can be arranged between the pedal 12 and the support frame 11, the pedal 12 can be movably connected to the support frame 11, and the first position sensor 13 can be located beside the fulcrum.

Referring to FIG. 1, two pedal areas 111 can be defined on a side of the support frame 11 away from the ground. The vehicle body can include two pedals 12. The two pedals 12 can be respectively disposed in the two pedal areas 111. When the attitude information of the two pedals 12 is asymmetrical, the vehicle body 10 makes turns. That is, by the user standing on the pedal 12 with a left foot or right foot, the vehicle body 10 makes turn or moves forward or backward.

Preferably, the attitude information can be tilt information. The first position sensor 13 can detect rotation information or tilt information of the pedal 12 relative to the support frame 11. The controller 15 can control the pair of wheels 20 to rotate according to the tilt information detected by the first position sensor 13. The controller 15 can control the pair of wheels 20 to not only move forward but also move backward or stop. Alternatively, the attitude information can be position information. The first position sensor 13 can detect position information of the user standing on the pedal 12. The controller 15 can control the pair of wheels 20 to rotate according to the position information detected by the first position sensor 13. The position information of the user on the pedal 12 can be detected in arbitrary position of the 3D space. It should be pointed out that the position information can be a center of gravity of the user.

Preferably, the first position sensor 13 can include a flexible element arranged between the pedal 12 and the support frame 11. The first position sensor 13 can detect the attitude information of the user standing on the pedal 12 based on deformation in arbitrary directions of the flexible element. In one embodiment, the first position sensor 13 can be the flexible element itself, that is, the first position sensor 13 and the flexible element are integrated into a whole, the first position sensor 13 detecting deformation itself to obtain the attitude information of the user standing on the pedal. In another embodiment, a flexible support can be provided and separate from the first position sensor 13, the first position sensor 13 detecting deformation of the flexible support to obtain the attitude information of the user standing on the pedal.

Alternatively, the first position sensor 13 can detect deformation amount of the flexible element based on original balancing position of the flexible element, in order to obtain the attitude information of the user standing on the pedal 12. For example, the deformation amount of the flexible element can be detected by the changing of center of gravity of the deformed flexible element.

Alternatively, at least two flexible elements (not shown) can be located in arbitrary positions between the pedal 12 and the support frame 11. The first position sensor 13 can detect deformation of the at least two flexible elements to obtain the position information of the user standing on the pedal.

The first position sensor 13 can be a pressure sensor configured to detect pressure of the pedal 12, in order to obtain the attitude information of the user standing on the pedal 12. The pedal 12 can include the footboard 127 separate from the pressure sensor. The pressure sensor can be arranged under the footboard 127 and configured to detect the pressure value of the footboard 127 pressing downward. For example, the pedal 12 can be rotatably connected to the support frame 11, and the first position sensor 13 can detect the pressure information when the pedal 12 is rotated. Also, the pedal 12 can be rotatably connected to the support frame 11, and the pressure sensor can detect minor tilt angles of the footboard 127 relative to the support frame 11, in order to obtain the pressure information of the user.

A plurality of pressure sensors can be arranged in the pedal 12, and configured to detect the pressure information of the user standing on the pedal 12.

The attitude information can also be pressure information. The first position sensor 13 can be configured to detect pressure information of the pedal 12. Preferably, the footboard 127 of the pedal 12 can be a capacitor installation (e.g., capacitance) or inductance device. Thus the first position sensor 13 can be configured to detect the pressure value of the user standing on the pedal 12. The controller 15 can control the pair of wheels 20 to rotate according to the pressure value, and make turns according to a speed difference between the pair of wheels 20.

Preferably, the first position sensor 13 can also be configured to sense whether the pedal 12 is pressed or not in order to control the pair of wheels 20 to rotate or not rotate. Thus, the first position sensor 13 can sense a plurality of information. The result is a simple internal structure of the vehicle body 10, which can be assembled easily. Alternatively, the vehicle body 10 can further include an inductive switch 14. The inductive switch 14 can be configured to sense whether the pedal 12 is pressed or not in order to control the pair of wheels 20 to rotate or stop rotation. The inductive switch 14 can be integrated into the first position sensor 13, integrated into the flexible element, integrated into the flexible support 17, or assembled outside of the first position sensor 13, the flexible element, or the flexible support 17.

The first position sensor 13 can be a tracking ball in the pedal 12. The tracking ball can have a capability of freely moving in arbitrary directions. The attitude information of the user standing on the pedal 12 can be obtained by detecting rotation position of the tracking ball relative to the pedal 12. There may be two ways, the first being that the first position sensor 13 itself can be the tracking ball, and can detect the attitude information of the user standing on the pedal 12 by detecting rotation information of itself relative to the pedal 12. The second being that the first position sensor 13 can be separated from the tracking ball, and can detect the attitude information of the user standing on the pedal 12 by detecting rotation information of the tracking ball relative to the pedal 12.

Preferably, the vehicle body 10 can further include a second position sensor configured to detect the tilt information of the support frame 11 relative to the ground. The controller 15 can control the human-machine interaction vehicle 100 to move forward or backward based on the tilt information detected by the second position sensor. The controller can control the human-machine interaction vehicle 100 to make turns based on the attitude information detected by the first position sensor 13. The second position sensor can be a gyroscope, a pressure sensor, a photoelectric sensor, and so on. The gyroscope can be fixed on a circuit board inside the support frame 11. The circuit board can be a whole piece, or divided into two pieces. For example, when the user and the support frame 11 tilts forward, a tilt information can be detected by the gyroscope and sent to the controller. The controller can control the wheels 20 to move forward, and a whole of the vehicle body can be controlled by a backward tilt force, resulting in balancing effect.

Another embodiment of the human-machine interaction vehicle can include two pedals and the attitude information is tilt information. If the first position sensor 13 detects a minor tilt angle or a minor difference of tilt angles between the two pedals 13, the vehicle body 10 can move forward or backward. If the first position sensor 13 detects a greater left tilt angle or a large difference of tilt angles between the two pedals 13, the vehicle body 10 can make, for example, a left-turn. The first positions sensor 13 can be of any detecting type. The first positions sensor 13 can include gyroscope, a pressure sensor, or a photoelectric sensor. If the first position sensor 13 is a pressure sensor, the pedals 12 can be rotatably connected to the support frame 11, or fixed to the support frame 11. The number of the first position sensor 13 can be arbitrary. The position of the first position sensor 13 can be arbitrary. In this embodiment, the vehicle body 10 includes a first position sensor 13. The first position sensor 13 can be arranged on the inductive switch 14. Alternatively, the first position sensor 13 can be integrated into the inductive switch 14. The vehicle body 10 can further include a second position sensor configured to detect a tilt information of the support frame 11 relative to the wheels 20, in order to obtain tilt information of the support frame 11 relative to the ground. The actuation device is configured to drive the wheels to rotate based on the tilt information detected by the second position sensor. That is, the human-machine interaction vehicle 100 can move forward or backward based on the tilt angle of the vehicle body 10. The angle speeds of the wheels controlled by the actuation device are the same. The actuation device can drive the human-machine interaction vehicle 100 to make turns based on the tilt information detected by the first position sensor 13. The human-machine interaction vehicle 100 can makes turns based on the tilt angle of the pedals 12, which is also based on the difference in rotate speed between the two wheels 20. In this embodiment, the first position sensor 13 and/or the second position sensor can be arranged on the sub-circuit board 124. The sub-circuit board 124 can be fixed to the pedal 12. The first position sensor 13 on the sub-circuit board 124 can sway with the footboard 127, in order to sense the movement of the footboard 127. A plurality of mounting pillars 125 can be extended from the footboard 127 and configured to fix the sub-circuit board 124. Also, the first position sensor 13 can be connected to the footboard 127 by any arbitrary means, in order to sway with the footboard 127.

This disclosure includes the following embodiments and any other embodiments obtained by those of skilled in the art without making inventive efforts shall be covered.

In one embodiment, when the attitude information is regarded as tilt information and the pedal 12 is rotatably connected to the vehicle body 10, the human-machine interaction vehicle 100 can include a sole pedal 12 configured for two feet standing, in which the controller 15 can drive the wheels 20 to rotate based on the tilt information of the pedal 12. Alternatively, the human-machine interaction vehicle 100 can include two pedals 12 configured for two feet standing, in which the controller 15 can drive the wheels 20 to rotate based on a difference of the tilt information of the two pedals 12. As another option the human-machine interaction vehicle 100 can include a sole pedal 12 configured for one foot standing, in which the controller 15 can drive the wheels 20 to rotate based on the tilt information of the pedal 12.

In another embodiment, when the attitude information is regarded as position information and at least one flexible support is arranged between the pedal 12 and the vehicle body 10, the human-machine interaction vehicle 100 can include a sole pedal 12 configured for two feet standing, in which the at least one flexible support can be arranged under the pedal 12, and the controller 15 can drive the wheels 20 to rotate based on the deformation amount of the at least one flexible support pressed by the user on the pedal 12. Alternatively, the human-machine interaction vehicle 100 can include two pedals 12 configured for two feet standing, respectively, in which the at least two flexible supports can be arranged under the two pedals 12, respectively, and the controller 15 can drive the wheels 20 to rotate based on the difference of deformation amount of the at least two flexible supports pressed by the user on the pedal 12. As another option, the human-machine interaction vehicle 100 can include a sole pedal 12 configured for one foot standing, in which the at least one flexible support is arranged under the pedal 12, and the controller 15 can drive the wheels 20 to rotate based on the deformation amount of the at least one flexible support pressed by the user on the pedal 12.

In yet another embodiment, when the attitude information is regarded as pressure information and at least one mechanical pressure sensor is arranged between the pedal 12 and the vehicle body 10, and the pedal 12 is rotatably connected to the vehicle body 10 or regarded as rotatably connected to the vehicle body 10 with a minor tilt angle between each other, the human-machine interaction vehicle 100 can include a sole pedal 12 configured for two feet standing, in which the at least one pressure sensor is arranged under the pedal 12, and the controller 15 can drive the wheels 20 to rotate based on the pressure information of the user standing on the pedal 12. Alternatively, the human-machine interaction vehicle 100 can include two pedals 12 configured for two feet standing, respectively, in which the at least one pressure sensor is arranged under the pedals 12, and the controller 15 can drive the wheels 20 to rotate based on the difference of pressure information of the user standing on the two pedals 12. As another option, the human-machine interaction vehicle 100 can include a sole pedal 12 configured for one foot standing, in which the at least one pressure sensor is arranged under the pedal 12, and the controller 15 can drive the wheels 20 to rotate based on the pressure information of the user standing on the pedal 12.

In another embodiment, when the attitude information is regarded as pressure information, and the pedal 12 is a capacitance or inductance pressure sensor itself, the human-machine interaction vehicle 100 can include a sole pedal 12 configured for two feet standing, in which the controller 15 can drive the wheels 20 to rotate based on the detected capacitance or inductance pressure information of different positions of the user standing on the pedal 12. Alternatively, the human-machine interaction vehicle 100 can include two pedals 12 configured for two feet standing, respectively, in which the controller 15 can drive the wheels 20 to rotate based on the difference of pressure information of the user standing on the two pedals 12. As another option, the human-machine interaction vehicle 100 can include a sole pedal 12 configured for one foot standing, in which the controller 15 can drive the wheels 20 to rotate based on the pressure information of different positions of the user standing on the pedal 12.

In another embodiment, when the first position sensor 13 is a tracking ball and the attitude information is regarded as rotation information of the tracking ball, the human-machine interaction vehicle 100 can include a sole pedal 12 configured for two feet standing, in which the controller 15 can drive the wheels 20 to rotate based on the rotation information of the tracking ball. Alternatively, the human-machine interaction vehicle 100 can include two pedals 12 configured for two feet standing, in which the controller 15 can drive the wheels 20 to rotate based on the difference of rotation information of the two tracking balls. As another option, the human-machine interaction vehicle 100 can include a sole pedal 12 configured for one foot standing, in which the controller 15 can drive the wheels 20 to rotate based on the rotation information of the tracking ball.

Referring to FIG. 7, another human-machine interaction vehicle 200 of the second embodiment is provided. The first position sensor can detect a rotate angle of the pedal 212 to detect a tilt angle of the pedal 212 relative to the support frame 211, in which the support frame 211 can be a rigid shaft. The pedal 212 can be sheathed in the rigid shaft and rotatably connected to the support frame 211. The first position sensor can be arranged between the support frame 211 and the rigid shaft and configured to detect a tilt angle of the support frame 211 relative to the rigid shaft. When the first position sensor is a pressure sensor, the pressure sensor can be used to detect pressure information, gravity information, or position information of the pedal. The pressure sensor can detect a minor rotate angle or tilt angle of the support frame 211 relative to the rigid shaft. Although the rotate angle or tilt angle may be in a tiny scale, the support frame 211 and the rigid shaft can be regarded as rotatably connected.

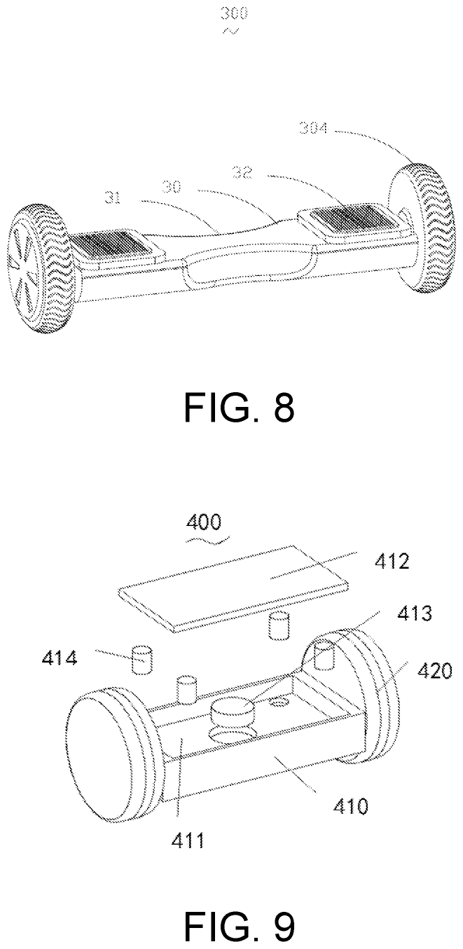

Referring to FIG. 8, another human-machine interaction vehicle 300 is provided. The human-machine interaction vehicle 300 can include a vehicle body 30 and a pair of wheels 304 arranged to the vehicle body 30. The wheels 304 can rotate on the vehicle body 30 along an axle of the wheels. The vehicle body 30 can further include a support frame 31 and two pedals 32 located on the support frame 31. The support frame 31 can be an integrated structure and rotatably connected to the wheels 304. A pressure sensor can be arranged on the pedal 32 and configured to detect pressure information, gravity information, or position information of the two pedals 32. The human-machine interaction vehicle 300 can further include a controller configured to drive the wheels to rotate based on the detected pressure information, gravity information, or position information. The controller can be arranged inside of the vehicle body. The pedals 32 can be fixed to the support frame 31, or rotatably connected to the support frame 31. The words “rotatably connected” can mean that the pedals 32 rotate on an axis of the support frame 31, and the rotate information can be understood as tilt information. Furthermore, the rotate angle can be arbitrary, for example, in the embodiment of the pedal rotating on the axle of a wheel or flexible support arranged in the pedal, the tilt angle or rotate angle may be large. In one example, except for a pressure sensor rotatably connected, when a pressure sensor is provided in a plane surface of the pedal area, although the rotate angle or tilt angle is in a tiny scale, the support frame 31 and the rigid shaft can be regarded as rotatably connected. If the pressure sensor is attached on the support frame 31, and the rotate angle or tilt angle detected by pressure distribution is in a tiny scale, the support frame 31 and the pedal can be regarded as rotatably connected. Alternatively, when the pedal area is plane, the pedal 32 can be fixed to the support frame 31.

When the user stands on the two pedals 32 and the position information, gravity information, or pressure information of the two pedals 32 is unequal, the vehicle body 30 can make turns.

The controller can be used to control the wheels 304 to rotate according to pressure information of the two pedals 32. The vehicle body can makes left or right turns according to pressure information of left and right pedals 32. If the pressure information of left and right pedals 32 are unequal, the left wheel 304 can have a greater speed than the right wheel, resulting in the vehicle body making a left turn, and the left pedal and the right pedal may be slightly tilted. The gravity information can be regarded as tilt information and a gravity distribution can be detected by the pressure sensor. Although the rotate angle or tilt angle is in a tiny scale, the pedals can be regarded as being tilted and have a minor tilt angle.

The pressure sensor can detect if there is a user standing on the pedal or not, and control the wheels 304 to rotate or stop. In this embodiment, an inductive switch configured to detect whether the pedal is pressed or not is unnecessary, in order to simplify the structure of the vehicle body.

The pedal 32 can include a footboard and a non-slip mat arranged on the footboard. The pressure sensor can be arranged under the footboard. When an user stands on the pedal, the pressure information can be detected by the pressure sensor and sent to the controller by an electric conductive coil.

When the whole of the vehicle body 30 tilts forward or backward, the vehicle body 30 moves forward or backward.

The human-machine interaction vehicle 300 further includes a second position sensor configured to detect tilt information of the support frame 31 relative to the wheels 304.

Referring to FIG. 9, another human-machine interaction vehicle 400 is provided. The human-machine interaction vehicle 400 can include a sole pedal 12 configured for two feet standing. Four flexible supports can be arranged between the pedal 412 and the support frame 411. The first position sensor 413 can detect deformation amount of the four flexible supports based on the balancing position of the four flexible supports, resulting in rotation of the wheels 420. Preferably, the inductive switch can be integrated into the flexible supports. Alternatively, the inductive switch can be omitted.

The description above is merely exemplary embodiments of the present disclosure, but is not intended to limit the disclosure. Any modifications, substitutions, or improvements made without departing from the spirits and scope of the disclosure shall all fall within the protection of the disclosure.

What is claimed is:

1. A human-machine interaction vehicle comprising a vehicle body and a pair of wheels coupled with the vehicle body, wherein the vehicle body comprises a support frame, at least one pedal, a first position sensor, and a controller, the at least one pedal is located on the support frame, the support frame is rotatably connected to the pair of wheels, the first position sensor is configured to detect attitude information of a user standing on the at least one pedal, and the controller is configured to drive the wheels to rotate based on the detected attitude information, wherein the number of the at least one pedal is two, a protrusion facing towards the pair of wheels is provided at each side of the at least one pedal, and the at least one pedal is pivoted to the vehicle body via the protrusion.

2. The human-machine interaction vehicle of claim 1, wherein the at least one pedal is rotatably connected on the support frame, the attitude information comprises tilt angles, and the first position sensor is configured to detect a tilt angle of the at least one pedal relative to the support frame.

3. The human-machine interaction vehicle of claim 2, wherein the support frame is a rigid shaft, two opposite ends of the rigid shaft are rotatably connected to the pair of wheels, respectively, the first position sensor is configured to detect rotation angle of the at least one pedal relative to the rigid shaft, and the rotation angle is the tilt angle of the at least one pedal relative to the support frame.

4. The human-machine interaction vehicle of claim 1, wherein a receiving groove for receiving is defined on a side of the support frame.

5. The human-machine interaction vehicle of claim 1, wherein the at least one pedal comprises a plurality of flexible supports configured to make the at least one pedal return or buffer.

6. The human-machine interaction vehicle of claim 1, wherein the attitude information is position information, and the first position sensor is configured to detect the position information of the user standing on the at least one pedal.

7. The human-machine interaction vehicle of claim 6, wherein the vehicle body further comprises a plurality of flexible supports arranged between the at least one pedal and the support frame in different directions, and the first position sensor is configured to detect amounts of deformation of the flexible supports in different directions, in order to detect the position information of the user standing on the at least one pedal.

8. The human-machine interaction vehicle of claim 1, wherein the first position sensor is a pressure sensor, and the pressure sensor is configured to detect pressure on the at least one pedal, in order to detect the attitude information of the user standing on the at least one pedal.

9. The human-machine interaction vehicle of claim 8, wherein one or more pressure sensors are arranged in the at least one pedal.

10. The human-machine interaction vehicle of claim 1, wherein the attitude information is pressure information, and the first position sensor is configured to detect the pressure information of the at least one pedal.

11. The human-machine interaction vehicle of claim 10, wherein the first position sensor is configured to detect pressure value information of the user standing on the at least one pedal, and the controller is configured to drive the pair of wheels to rotate based on the detected pressure value information and make turns based on a speed difference of the pair of wheels.

12. The human-machine interaction vehicle of claim 1, wherein the first position sensor is further configured to detect whether the at least one pedal is pressed or not in order to respectively control the pair of wheels to rotate or stop.

13. The human-machine interaction vehicle of claim 1, wherein a pedal area is defined on a side of the support frame away from a ground and configured for two feet standing, the at least one pedal is disposed in the pedal area, and when the attitude information in different directions is asymmetrical, the vehicle body makes a turn.

14. The human-machine interaction vehicle of claim 13, wherein the first position sensor is arranged between the at least one pedal and the support frame, the at least one pedal is movably connected to the support frame, and the first position sensor is located beside a fulcrum.

15. The human-machine interaction vehicle of claim 1, wherein two pedal areas are defined on a side of the support frame away from the ground, the two pedals are respectively disposed in the two pedal areas, and when the attitude information of the two pedals is asymmetrical, the vehicle body makes a turn.

16. The human-machine interaction vehicle of claim 1, wherein a pedal area is defined on a side of the support frame away from the ground and configured for one foot standing, the vehicle body comprises a pedal, the pedal is respectively disposed in the pedal area, and the vehicle body makes a turn based on the attitude information of the pedal.

17. The human-machine interaction vehicle of claim 1, wherein the support frame is a rigid plate-type structure.

18. The human-machine interaction vehicle of claim 17, wherein an extractable shell is arranged on a side of the support frame, the extractable shell comprises a first shell and a second shell, the first shell and the second shell are extractable along a direction perpendicular to an axle of the wheels, the extractable shell comprises two end portions facing the wheels, a side portion for connecting the two end portions, a top portion away from the ground, a bottom portion facing the top portion, and a groove arranged on the top portion and configured to accommodate the at least one pedal.

19. The human-machine interaction vehicle of claim 18, wherein the first shell and the second shell are extractable forward or backward parallel to the ground.

20. The human-machine interaction vehicle of claim 1, wherein the vehicle body further comprises a second position sensor, and the second position sensor is configured to detect tilt information of the support frame relative to the ground, the controller is configured to drive the wheels to move forward or backward based on the tilt information detected by the second position sensor, and the controller is configured to drive the wheels to make a turn based on the attitude information detected by the first position sensor.
